(19) United States
(12) Patent Application Publication
(10) Pub. No.: US 2003/0028987 A1
(43) Pub. Date: Feb. 13, 2003

(54) Decorated personal grooming device and method and apparatus for making same

(76) Inventors: Linda Morawski, Robbinsville, NJ (US); Richard M. Prospero, Princeton, NJ (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 10/272,271

(22) Filed: Oct. 16, 2002

Related U.S. Application Data
(63) Continuation of application No. 09/758,529, filed on Jan. 11, 2001.
Application No. 09/758,529 is a continuation of application No. 09/218,405, filed on Dec. 22, 1998, now abandoned.

(51) Int. Cl. A46B 5/02; A46B 9/04; B32B 31/00

(52) U.S. Cl. 15/167.1; 156/85; 156/86; 15/143.1

(57) ABSTRACT

Decorated personal grooming devices, and particularly, decorated toothbrushes, comprise a handle, a neck and a head. The devices further comprise a plastic film having a decorative pattern thereon, said film being in conforming contact with at least a portion of the handle. When the device of the invention is a toothbrush, it further comprises bristles attached to said head. A toothbrush of the invention may be decorated by providing a toothbrush body having a handle, a neck and a head; providing a heat-shrinkable plastic film in tubular form having a decorative pattern thereon; positioning the tubular film around at least a portion of the handle such that the portion of the handle is contained in the interior region of the tubular film; and heating the film to a temperature and for a time sufficient to cause the film to shrink into conforming contact with the toothbrush handle.

### FIELD OF THE INVENTION

The present invention is directed to decorated personal grooming devices, particularly decorated toothbrushes, and to methods and apparatus for making such decorated devices.

### BACKGROUND OF THE INVENTION

Regular brushing of the teeth is a fundamental requirement of proper oral hygiene. It is generally recognized that it is difficult to achieve compliance with such regimens, particularly among children. One approach to improving compliance is to decorate the toothbrush handle in a manner which will be attractive to children and which will facilitate their use of the brush. One method of decorating toothbrushes that has been used involves affixing decals to the toothbrush handle. This method generally does not permit the positioning of decorative elements about the entire handle perimeter, and the decorated elements are not especially durable. Another method that has been used to decorate toothbrushes is to prepare the toothbrush handle in a two step process in which the toothbrush body is formed out of a material such as polypropylene in a first injection molding step, and a thermoplastic elastomer is injected around the first-formed body in a second molding step. While this technique does permit the development of a decorative element which completely circumscribes the perimeter of the brush handle, this method requires more costly molds and raw materials and more intricate processing. Another disadvantage of this method is that the decorative element is produced by the mold body, and changing the decorative element requires a costly change in the mold.

Accordingly, one object of the invention is to provide a personal grooming device such as a toothbrush which permits the use of decorative elements that completely surround the handle of the device.

It is another objective of the invention to provide a method of decorating personal grooming devices such as toothbrushes in a virtually limitless number of patterns and motifs.

It is another object of the invention to provide a method of decorating personal grooming devices such as toothbrushes with different designs that do not require separate molds for achieving different designs.

These and other objects will become apparent from the following description of the invention.

### SUMMARY OF THE INVENTION

One aspect of the present invention relates to decorated personal grooming devices, and particularly, to decorated toothbrushes. The decorated devices of the invention comprise a handle, a neck and a head. The devices of the invention further comprise a plastic film having a decorative pattern thereon in conforming contact with at least a portion of the handle. When the device of the invention is a toothbrush, it further comprises bristles attached to said head.

Another aspect of the invention relates to a method for decorating a personal grooming device. In the case of a toothbrush, the method comprises the steps of:

a) providing a toothbrush having a handle, a neck and a head;

b) providing a heat-shrinkable plastic film in tubular form having a decorative pattern thereon, the tube defining an interior region bounded by the film;

c) positioning the tubular film around at least a portion of the handle such that the portion of the handle is contained in the interior region of the tubular film; and

d) heating the film to a temperature and for a time sufficient to cause the film to shrink into conforming contact with the toothbrush handle.

A more preferred method of decorating devices such as a toothbrush comprises the steps of:

a) providing a toothbrush having a handle, a neck and a head;

b) providing a heat-shrinkable plastic film in tubular form having a decorative pattern thereon, the tube defining an interior region bounded by the film;

c) bringing the toothbrush into engagement with a fixture;

d) positioning the tubular film around at least a portion of the handle such that the portion of the handle is contained in the interior region of said tubular film;

e) conveying the toothbrush to a heating station;

f) heating the film to a temperature and for a time sufficient to cause the film to shrink into conforming contact with the handle.

Another aspect of the invention is related to an apparatus to decorate a personal grooming device such as a toothbrush, said apparatus comprising:

a) a fixture to engage the toothbrush;

b) means to convey the toothbrush to a heating station; and

c) means for heating a heat-shrinkable film surrounding at least a portion of a toothbrush handle so as to cause the film to conform to the portion of the handle.

### BRIEF DESCRIPTION OF THE DRAWINGS

FIG. 1A depicts a perspective view of a decorated toothbrush of the invention.

FIG. 1B depicts a top plan view of a decorated toothbrush of the invention.

FIG. 1C depicts a side elevation view of a decorated toothbrush of the invention.

FIG. 1D depicts a bottom plan view of a decorated toothbrush of the invention.

FIG. 1E depicts a perspective view of a tubular film used to decorate the toothbrush of the invention.

FIG. 2 depicts a side elevation view of a toothbrush body used in one embodiment of the toothbrush of the invention and several cross-sectional views of the toothbrush handle at various locations along the handle axis.

FIG. 3A depicts a top plan view of a toothbrush body used in the decorated toothbrush of the invention.

FIG. 3B depicts the toothbrush body of FIG. 3A wherein a portion of the toothbrush handle is contained within the interior of a tubular film of heat-shrinkable material.

FIG. 3C depicts a toothbrush body wherein a decorative film of a heat shrinkable material has been made to conform to at least a portion of the toothbrush handle.

FIG. 4A and FIG. 4B depict a toothbrush body immobilized in a fixture in top plan view and in side view, respectively.

FIG. 4C depicts a toothbrush body in a fixture in which a tubular film is positioned about a portion of the toothbrush handle.

FIG. 4D depicts a toothbrush body held in a fixture, said toothbrush having a handle with a tubular film mounted thereon, said toothbrush handle contained in a heating zone.

FIG. 4E depicts the toothbrush body of FIG. 4C after the tubular heat-shrinkable film has been heated and made to come into conforming contact with at least a portion of the toothbrush handle.

### DETAILED DESCRIPTION OF THE INVENTION

The present invention relates to decorated personal grooming devices, methods to decorate said devices and apparatus used to decorate said devices. The decorated devices of the invention are characterized by having a handle at one of their ends by which they may be held in the hand of a user, and a working tool at the end of the device opposite the handle, said tool being used to perform some useful function such as combing the hair or brushing the teeth. The device also usually contains a neck portion intermediate and serving to connect the working tool and the handle. The decorated devices of the invention include toothbrushes, hair brushes, hair combs, cosmetic applicator brushes, body scrub brushes and shaving razors. A decorated toothbrush is a preferred device of the invention.

For illustrative purposes, the device of the invention as well as methods and apparatus relating thereto will hereinafter be described in the form of a toothbrush, although it will be recognized that the inventive device as well as methods and apparatus relating thereto include all of the above-enumerated embodiments.

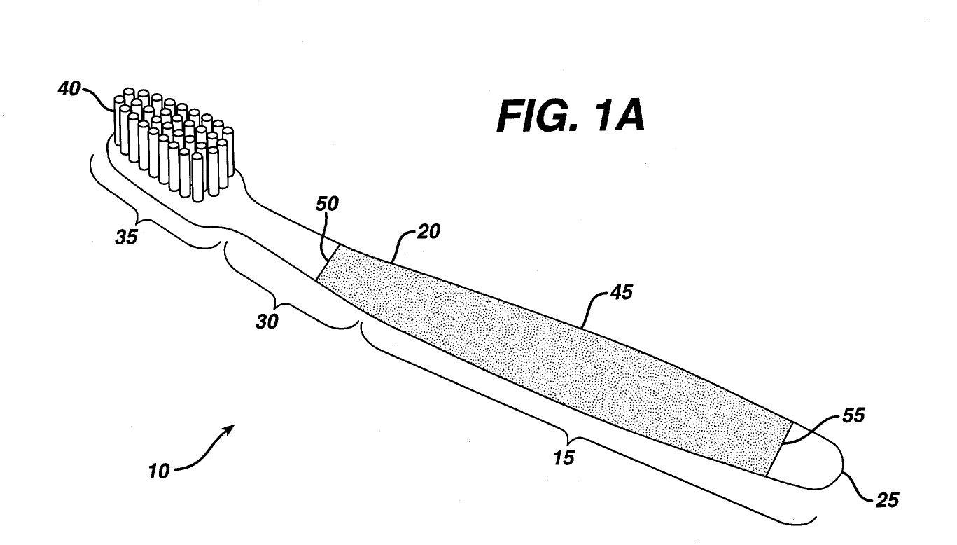

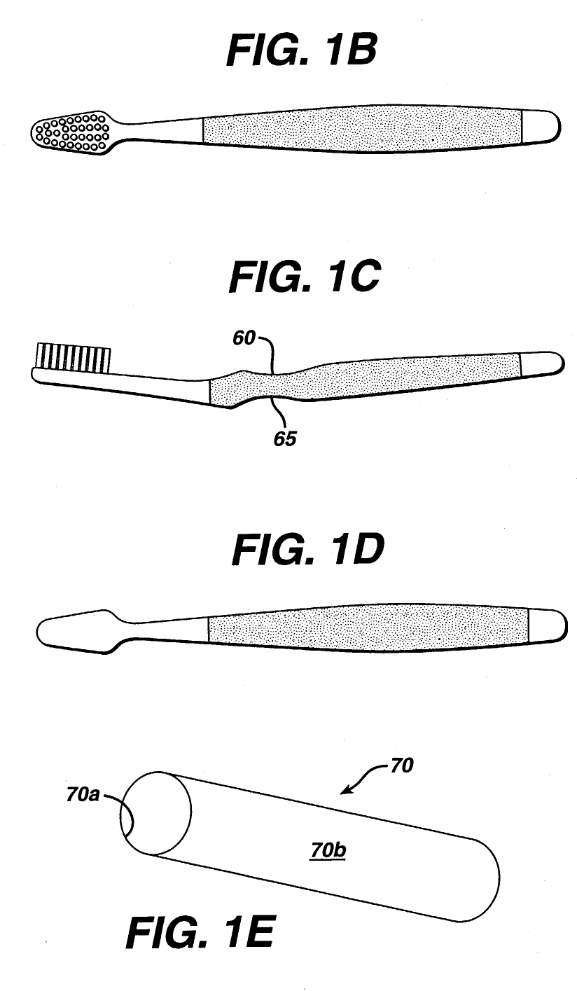

A preferred embodiment of a decorated toothbrush of the invention is shown in perspective view in FIG. 1A. The toothbrush 10 comprises a handle 15 having a proximal end 20 and a distal end 25. The toothbrush further comprises a neck 30 adjacent said proximal end 20 of handle 15 which serves to connect handle 15 with head 35. Head 35 further comprises bristles 40 affixed thereto. Toothbrush 10 of the invention further comprises a plastic film 45, represented by the dark section on handle 15, having a decorative pattern thereon. The inner surface of decorated tubular plastic film 45 is in conforming contact with the outer surface of at least a portion of handle 15. FIG. 1B, FIG. 1C and FIG. 1D show the brush of FIG. 1A in top plan, side and bottom plan views, respectively.

Handle 15, neck 30 and head 35 together comprise the body of brush 10. The toothbrush body is typically of unitary construction, although non-unitary toothbrush bodies, for example, wherein the toothbrush head may be separable from the brush neck, may also be decorated by the method of the invention. The toothbrush body is typically fabricated from plastic materials by injection molding techniques well known in the art. The toothbrush body is typically molded with a series of tuft holes in its head to permit fastening of tufts of bristles thereto, as, for example, by so-called stapling techniques well known in the art.

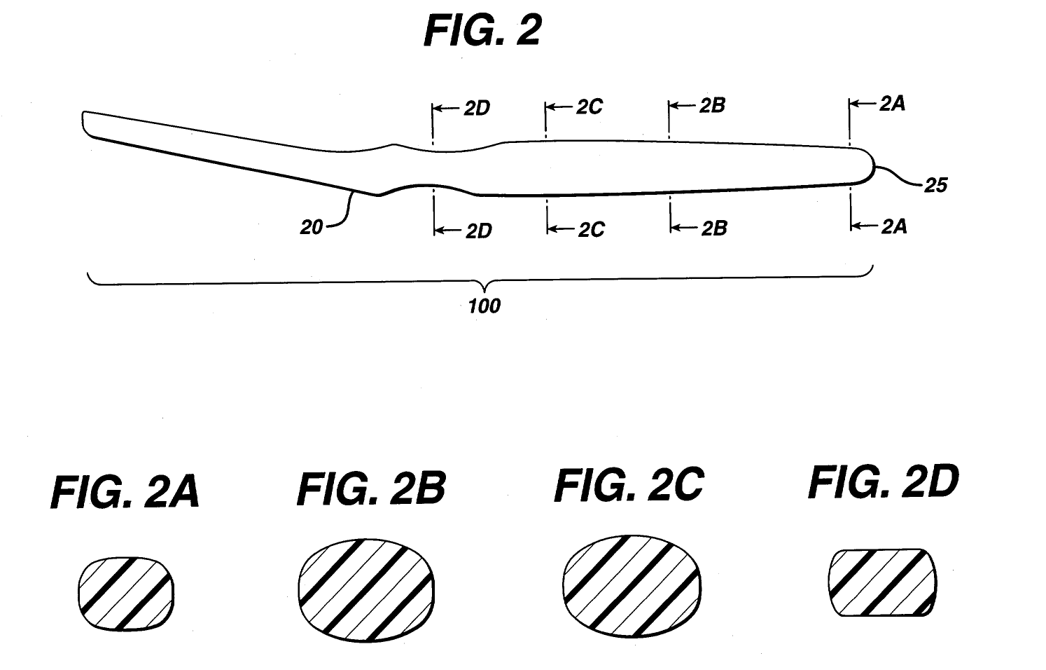

FIG. 2 shows a side view of toothbrush body 100 of the brush 10 of FIG. 1A and a series of cross-sectional views of the brush body at various points of its handle. The cross-section of toothbrush handle 15 perpendicular to the longitudinal axis of the handle is preferably not uniform along the handle length. Rather, as shown in FIG. 2, the cross-sectional area perpendicular to the longitudinal axis of the handle first increases from its distal end 25, reaches a maximum (in the region of lines B-B and C-C of FIG. 2) and then decreases as it approaches proximal end 20 of the handle. The presence of a maximum diameter along the handle intermediate its distal and proximal ends provides mechanical anchoring which prevents the film from slipping off the handle.

Any edges on the toothbrush body in contact with the film are preferably sufficiently rounded to prevent such edges from tearing the film. An edge radius of at least 0.01 inches is generally sufficient to prevent tearing of the film.

The topography of the toothbrush handle is preferably free of any concave surfaces in any cross-section perpendicular to the longitudinal axis of the handle. The presence of any such concave surface might cause the film to span across regions of the handle in which the film would not be in conforming contact, which could, in turn, cause the film to fail when the brush is in use.

As shown in FIG. 1A, film 45 has a proximal end 50 and a distal end 55. In this embodiment, proximal end 50 of film 45 extends beyond proximal end 20 of handle 15 so as to be in conforming contact with a portion of neck 30 of toothbrush 10. The extension of proximal end 50 of film 45 beyond proximal end 20 of handle 15 onto a portion of neck 30 minimizes contact of end 50 by the fingers during use of the brush, and any concomitant distortion of the film that might be caused by such contact.

In the preferred embodiment of the toothbrush of the invention shown in FIGS. 1A through 1D, brush handle 15 comprises indentations 60 and 65 on the upper and lower surfaces, respectively, of handle 15 which can be grasped by the thumb and index finger during use. The brush of the invention preferably comprises at least one and more preferably two of such indentations to prevent the brush from slipping from the hands during use.

The decorative film in conforming contact with the toothbrush handle is typically provided as a heat-shrinkable film in tubular form. As shown in FIG. 1E, the tubular film 70 has a first, interior surface 70a which, in the decorated brush of the invention, is in contact with the outer surface of a portion of the toothbrush handle, and a second, exterior surface 70b. The decorative pattern which is ultimately desired on the brush of the invention is preferably applied to a clear, heat shrinkable plastic film in sheet form using conventional printing techniques known in the art. Once the film is printed, it is transformed into a tubular configuration using edge seaming techniques such as solvent or adhesive sealing techniques, or by thermally fusing the edges into a tubular form. The decorative pattern is preferably applied to that surface of the film which will become the interior of the tube, i.e., on the interior, handle-facing first surface 70a of tubular film 70. By having the decorated pattern on the surface of the film facing the toothbrush handle, the decorative pattern is protected from wear during use of the brush. One skilled in the art will recognize that the decorative pattern may be applied to the exterior surface 70b of tubular film 70, i.e., on the surface contacted by the user of the brush during use.

The method of the invention provides a virtually limitless number of motifs that may be used in the decorated devices of the invention. For example, the decorative patterns may be selected from colors, text, pictures, cartoon characters, lines, geometric shapes or patterns or combinations of these motifs.

Heat shrinkable films used in decorating the devices of the invention are obtained by stretching and orienting films as they are extruded. The orientation of the film during processing is believed to introduce a “memory” effect which causes the film to shrink to a relaxed configuration upon heating. Films may be shrinkable in either one or two directions depending on whether the film is oriented in one direction (monoaxially) or in two directions (biaxially) during processing. The films used in decorating the devices of the invention are preferably monoaxially oriented and are heat-shrinkable primarily in one direction on heating. In the tubular films used to decorate the devices of the invention, the films were found to shrink by up to about 60 percent in the circumferential direction but only by about two to three percent in the longitudinal direction.

The devices of the invention may, if desired, further comprise an adhesive layer intermediate the device handle and the interior surface of the film to improve the adhesion of the film to the handle. The adhesive layer may be conveniently provided as a heat-activated adhesive layer on the interior surface of the tubular plastic film. As will be hereinafter described, the decorated devices of the invention are made by applying a decorated, heat-shrinkable film in tubular form to the handle of the device and heating the film to a temperature and for a time sufficient to cause the film to shrink into conforming contact with the handle. If a heat-activated adhesive is used on the interior of the plastic film as described above, its characteristics are preferably chosen such that the adhesive becomes activated over the temperature range to which the film is subjected in the above-described heating step.

Devices of the invention, particularly combs and toothbrushes, are typically used in moist environments. As such, there is the possibility of liquid water seeping between the film and the device handle. Liquid water trapped between the film and the device handle may provide a breeding ground for bacterial growth. Accordingly, it is preferable that the films used in the devices of the invention be water vapor permeable to permit any water that might seep between the film and the handle to permeate through the film and away from the device when the device is not in use. Alternatively, the film or the handle of the device may be treated with an antibacterial agent or the like to retard bacterial growth.

The films used in the devices of the invention may be made of any heat-shrinkable plastic known in the art. Illustrative plastics useful for the films used in the devices of the invention include polyvinyl chloride (PVC) and polyester. One material useful in the films used in the devices of the invention is Eastar PETG Copolyester 6763, available from the Eastman Chemical Co. of Kingsport, Tenn. This material is comprised of poly (ethylene-1,4-cyclohexylenedimethylene terephthalate) and is a preferred polyester for use in the films used in the devices of the invention.

The handle of the device may be made of any material known in the art to be useful for such devices. Since the device is decorated by heating a heat-shrinkable tubular film positioned around the handle for a temperature and for a time sufficient to shrink the film into conforming contact with the handle, the material comprising the handle must obviously be capable of withstanding the heating conditions used to shrink the film. The device may be made of any thermally resistant material such as plastic, wood, stone, or metal. Plastics are preferred materials for use in the devices of the invention. Exemplary thermally resistant plastics useful in the devices of the invention include polypropylene, nylon, polyester, cellulose esters such as cellulose acetate propionate, polyurethane, polystyrene, acrylonitrile-butadiene-styrene (ABS), and polymethyl methacrylate (PMMA), polypropylene being a preferred material for use as the body portion of the devices of the invention.

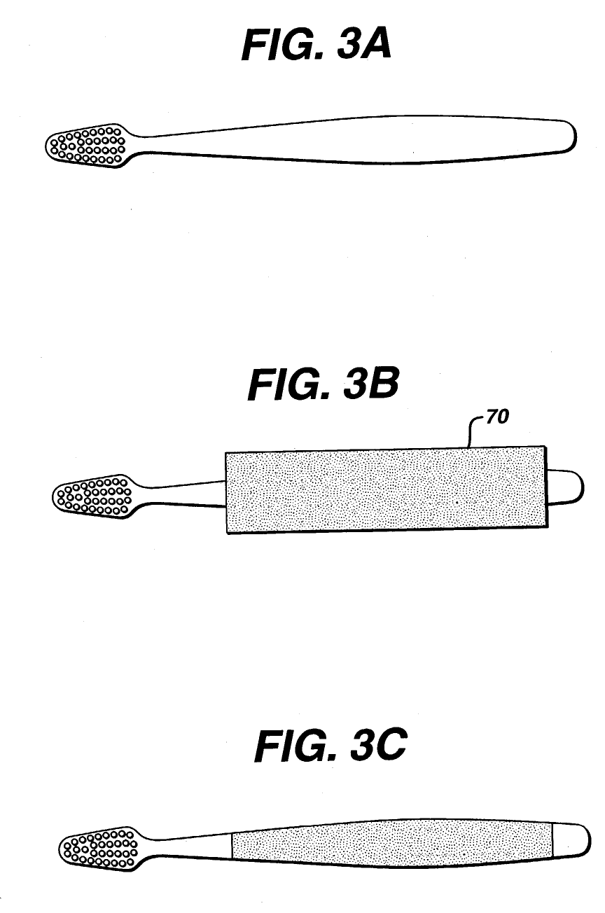

The various stages in the fabrication of the decorated brush of the invention are shown schematically in FIGS. 3A, 3B and 3C. FIG. 3A depicts the undecorated toothbrush body of FIG. 1A in top plan view. As shown in FIG. 3B, a tube of heat-shrinkable plastic film 70 having a decorated pattern thereon is positioned about at least a portion of the handle of the toothbrush body such that the portion of the handle is contained within the interior region of the tube. The tube of film 70 has an internal cross-sectional area that is sufficiently large to permit the film to be easily positioned around the handle. However, the film cross-sectional area should also be sufficiently small such that when the film is subjected to heat-shrinking, it comes into conforming contact with all desired portions of the toothbrush body. Typically, such films undergo a degree of shrinkage of up to about 60 percent in the circumferential direction when subjected to heat shrinking. Once the tubular film has been positioned on the toothbrush handle, it is then heated to a temperature and for a period of time sufficient to cause the film to shrink into conforming contact with the toothbrush handle as shown in FIG. 3C.

The inventive device, process and apparatus will now be illustrated by way of the following non-limiting example:

### EXAMPLE 1

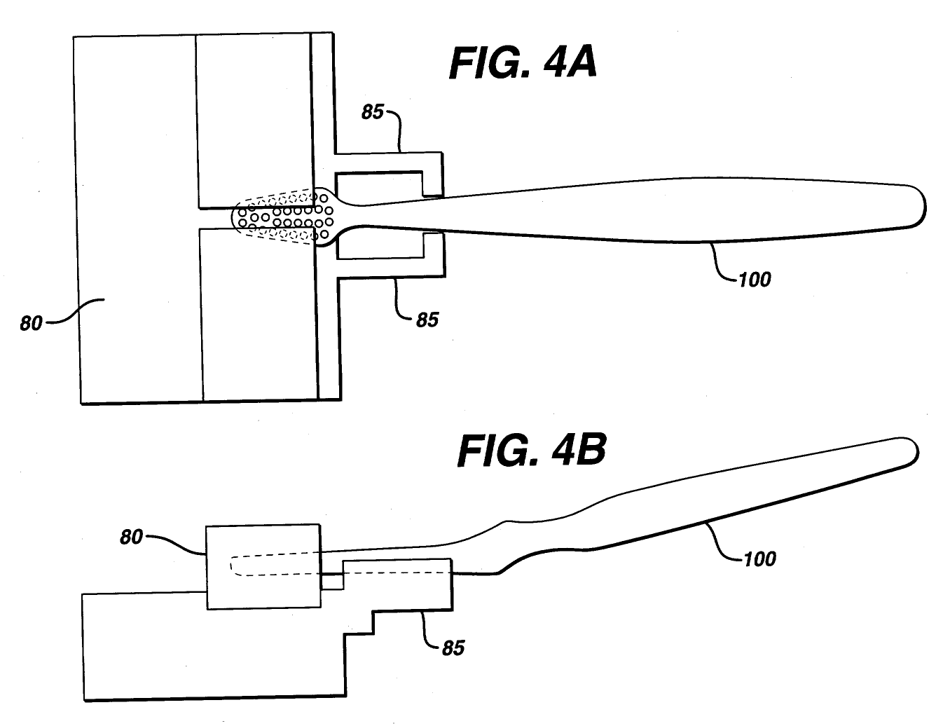

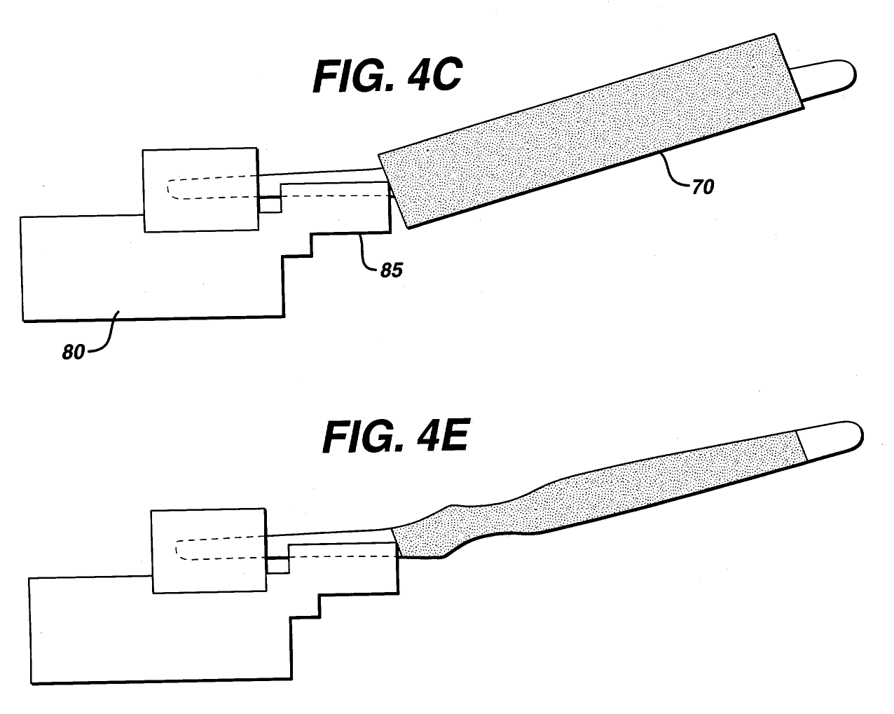

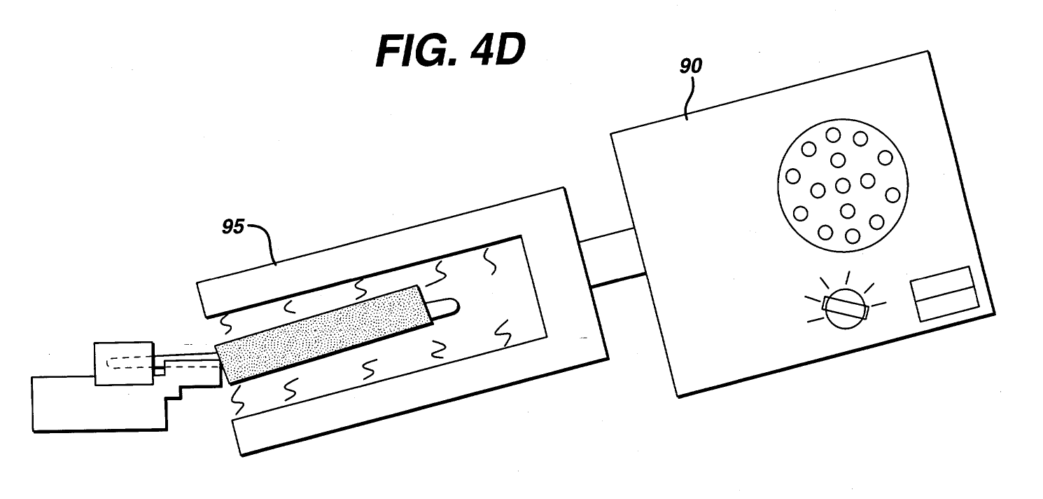

Referring to FIGS. 4A through 4D, a conveyor was fitted with a plurality of fixtures 80, each of which releasably engaged a toothbrush body 100 as shown in FIG. 4A and FIG. 4B. Fixture 80 comprises projection 85 which acts as a positioning or stop means to- maintain tubular film 70 in its desired longitudinal position along the handle of toothbrush body 100 prior to the heating step. A tubular film 70 in flattened form having a perimeter of 46 mm, a length of 98 mm and a thickness of 0.05 mm was positioned around each fixtured toothbrush handle such that the handle was contained within the interior region of the tubular film as shown in FIG. 4C. The tubular shrinkable films, obtained from American Fuji Seal Corp. of Fairfield, N.J., were comprised of Eastar PETG Copolyester 6763 poly (ethylene-1,4-cyclohexylenedimethylene terephthalate). The resultant toothbrush bodies containing the tubular film positioned thereon were conveyed, at a speed of about 40 ft/min, to a heating station comprising four contiguous heating zones. A toothbrush body having a tubular film 70 positioned around a portion of the toothbrush handle, the body and film positioned in a heating zone, is shown in FIG. 4D. Each zone contained a forced air heater 90 (Leister model Hotwind S 9C1, Leister, Kagiswil, Switzerland) connected to an 8″-wide plenum 95 which directed hot air at film 70 positioned about toothbrush body 100. The first two zones were configured to direct the heated air asymmetrically, i.e., to the bottom of the brush only while the second two plenums were configured to direct the hot air symmetrically, i.e., to both the top and bottom faces of the brush. The temperatures in the four heating zones were as follows:

Zone 1: 250° C.

Zone 2: 300° C

Zone 3: 300° C.

Zone 4: 325° C.

After emerging from the heating station, the film 70 was in conforming contact with the toothbrush body as shown in FIG. 4E.

The above-described configuration and operating conditions were found to be superior in terms of shrinking film 70 into conforming contact with toothbrush body 100 while avoiding or minimizing distortion of the decoration on the brush body, particularly on the upper surface of the brush handle.

Following passage through the heating station, the resultant decorated toothbrush bodies were allowed to cool and were removed from their fixtures. The decorated toothbrush bodies were then bristled using conventional bristling technology well known in the art.

1. A decorated toothbrush comprising:
a) a handle having proximal and distal ends, a neck and a head;
b) bristles attached to said head; and
c) a plastic film having a decorative pattern thereon in conforming contact with at least a portion of said handle.

2. The toothbrush of claim 1 wherein said plastic film completely surrounds said portion of said handle.

3. The toothbrush of claim 1 wherein said handle has a cross-sectional perimeter perpendicular to the longitudinal axis of said handle, said cross-sectional perimeter increasing and then decreasing from the distal end to the proximal end of said handle.

4. The toothbrush of claim 1 wherein the radius of any edge of said handle in contact with said film is at least about 0.01 inches.

5. The toothbrush of claim 1 wherein said portion of said handle is substantially free of concave surfaces in any cross-section perpendicular to the longitudinal axis of said handle.

6. The toothbrush of claim 1 wherein said film has a proximal edge in conforming contact with at least a portion of the neck of said brush.

7. The toothbrush of claim 1 wherein said handle further comprises at least one finger-gripping indentation.

8. The toothbrush of claim 7 comprising a first finger gripping indentation on the upper surface of said handle and a second finger gripping indentation on the lower surface of said handle.

9. The toothbrush of claim 1 wherein said film has a first side in contact with said handle and a second side, said decorative pattern being printed on said first side of said film.

10. The toothbrush of claim 1 wherein said decorative pattern is selected from colors, text, pictures, cartoon characters, lines, geometric shapes or patterns or combinations thereof.

11. The toothbrush of claim 1 which further comprises an adhesive layer intermediate said handle and said film.

12. The toothbrush of claim 1 wherein the film is permeable to water vapor.

13. The toothbrush of claim 1 wherein the film comprises a material selected from polyvinyl chloride and polyester.

14. The toothbrush of claim 13 wherein the polyester comprises glycol-modified polyethylene terephthalate.

15. A decorated personal grooming device comprising:
a) a handle, a neck and a head;
b) a plastic film having a decorative pattern thereon in conforming contact with at least a portion of said handle.

16. The personal grooming device of claim 15 wherein the device is selected from a toothbrush, a hair brush, a hair comb, a cosmetic applicator brush and a shaving razor.

17. Method of decorating a toothbrush body comprising:
a) providing a toothbrush body comprising a handle, a neck and a head;
b) providing a heat-shrinkable plastic film in tubular form having a decorative pattern thereon, said tube defining an interior region bounded by said film;
c) positioning said tubular film around at least a portion of said handle such that said portion of said handle is contained in the interior region of said tubular film; and
d) heating said film to a temperature and for a time sufficient to cause said film to shrink into conforming contact with said handle.

18. The method of claim 17 wherein bristles are attached to said toothbrush body after heating step (d).

19. The method of claim 17 wherein said toothbrush body is immobilized in a fixture prior to placing said film around said portion of said handle.

20. The method of claim 17 which further comprises conveying the toothbrush body to a heating station after step (c).

21. The method of claim 17 wherein said heating step is effected by directing heated air at said toothbrush body.

22. The method of claim 20 wherein said heating station comprises a plurality of heating zones.

23. The method of claim 20 wherein the temperature in said heating station is in the range of about 250° C. to about 325° C.

24. The method of claim 22 wherein said heating step is conducted at different temperatures in different zones.

25. The method of claim 22 wherein said film is asymmetrically heated in at least one zone and symmetrically heated in at least one other zone.

26. The method of claim 24 wherein the temperature increases in at least two successive heating zones.

27. Method of decorating a toothbrush body comprising:
a) providing a toothbrush body comprising a handle, a neck and a head;
b) providing a heat-shrinkable plastic film in tubular form having a decorative pattern thereon;
c) bringing the toothbrush into engagement with a fixture;
d) positioning said tubular film around at least a portion of said handle such that said portion of said handle is contained in the interior region of said film;
e) conveying said toothbrush to a heating station;
f) heating said film to a temperature and for a time sufficient to cause said film to shrink into conforming contact with said handle.

28. The method of claim 27 wherein said heating station comprises a plurality of heating zones.

29. The method of claim 27 wherein the temperature in said heating station is in the range of about 250° C. to about 325° C.

30. The method of claim 27 wherein said bristles are attached to said toothbrush body after heating step (f).

31. The method of claim 27 wherein said heating step is effected by directing heated air at said toothbrush body.

32. The method of claim 28 wherein said heating step is conducted at different temperatures in different zones.

33. The method of claim 28 wherein said film is asymmetrically heated in at least one zone and symmetrically heated in at least one other zone.

34. The method of claim 28 wherein the temperature increases in at least two successive heating zones.

35. Apparatus to prepare a decorated toothbrush, said toothbrush having a handle, a neck and a head, said handle having a plastic film in conforming contact thereto, said plastic film made from a heat-shrinkable material, said apparatus comprising:
a) a fixture to engage said toothbrush;
b) means to convey said toothbrush to a heating station; and
c) a heating station in which to heat said heat-shrinkable film so as to cause said film to conform to said toothbrush handle.

36. The apparatus of claim 35 wherein said heating station comprises multiple heating zones.

37. The apparatus of claim 36 wherein at least one heating zone heats the film symmetrically and at least one heating zone heats the film asymmetrically.

38. The apparatus of claim 35 wherein said fixture comprises positioning means to position said film on said handle.

39. A decorated toothbrush body comprising:
a) a handle having proximal and distal ends, a neck and a head; and
b) a plastic film having a decorative pattern thereon in conforming contact with at least a portion of said handle.
